(19) United States
(12) Patent Application Publication
(10) Pub. No.: US 2006/0096075 A1
(43) Pub. Date: May 11, 2006

(54) Clinching tool, die and method for use thereof

(76) Inventors: Victor Robinson, Port Sydney (CA); Philip Donaldson, Porcupine (CA)

Correspondence Address: SACCO & ASSOCIATES, PA, P.O. BOX 30999, PALM BEACH GARDENS, FL, 33420-0999, US

(21) Appl. No.: 10/983,799

(22) Filed: Nov. 8, 2004

(51) Int. Cl. B21D 39/00; B23Q 1/00

(52) U.S. Cl. 29/521; 29/283; 29/283.5; 29/796

(57) ABSTRACT

A clinching tool for mechanically interconnecting at least two stacked sheets manufactured of a ductile material comprises a punch and a die axially aligned thereto. The die cavity features a radiused surface profile at its closed end thus facilitating material flow therein during clinching action. This design, while minimizing tooling material stresses and reducing the likelihood of premature tooling failure, allows for clinch fastening of thicker sheets by forming a secure and distinguishable clinch.

### FIELD OF THE INVENTION

The present invention relates to clinching tools, dies and methods of their use. More specifically the present invention relates to punch and die assemblies for mechanically interconnecting ductile sheets of material of various thicknesses.

### BACKGROUND OF THE INVENTION

The process of clinching two metals together is a prior art that has been in the public domain for many years, however the existing art pertains to clinch joining relatively thin sheet materials, such as those used in the automotive and the durable goods (ranges, refrigerators) industries. These materials are thinner gauge, normally up to ⅛ inch (10 gauge) thickness.

The prior art reveals single stroke and double stroke methods for mechanically interconnecting sheets materials. The single stroke, for the most part, utilise expandable or multiple component dies. The multiple component dies are quite complicated, but are normally required to allow for material displacement to form the mechanical interconnection, without causing extremely high tooling material stresses and premature tooling failure. Double stroke methods typically include a die having a moveable anvil which, following a first step drawing an amount of the sheets being interconnected into the die, pushes the drawn material out the die prior to a subsequent compression step creating the mechanical interlock.

### SUMMARY OF THE INVENTION

In order to address the above and other drawbacks of the prior art, there is disclosed a die for use with a punch for mechanically interconnecting a plurality of sheets of a ductile material. The die comprises a die cavity comprising a closed end. An inner surface of the closed end has a raised surface profile.

There is also disclosed a clinching tool for mechanically interconnecting at least two stacked sheets of a ductile material. The clinching tool comprise a punch, a die comprising a die cavity, a closed end of the cavity having a raised surface profile, and a controllable source of pressure between the punch and the die. When the source of pressure is applied between the punch and die, the punch draws a clinch volume of the sheets substantially completely into the die cavity.

Additionally, there is disclosed a method for mechanically interconnecting at least two stacked sheets of a ductile material. The method comprises the steps of providing a die comprising a die cavity, a closed end of the cavity having a raised surface profile, drawing a clinch volume of the at least two sheets into the die cavity, the clinch volume being deformed by the die such that adjacent sheets mechanically interconnect, and stripping the sheets from the die.

Furthermore, there is disclosed a mechanically interconnected stack of ductile sheets. The stack comprises at least one region of deformation, wherein each of the sheets is deformed in the region of deformation, each of the deformations interacting together to form a mechanical bond and a protrusion on a first surface of the stack in the region of deformation, the protrusion comprising a curved depression towards a centre thereof.

There is also disclosed a one piece die for use with a punch for mechanically interconnecting at least two sheets of a ductile material. The die comprises a die cavity comprising a sidewall and a bottom wall, the bottom wall defining a raised surface within the cavity.

Additionally, there is disclosed a die for use with a punch for mechanically interconnecting at least two sheets of a ductile material. The die comprises a die cavity comprising a sidewall and a bottom wall, the bottom wall defining a curved surface within the cavity.

### BRIEF DESCRIPTION OF THE DRAWINGS

Having thus generally described the nature of the invention, reference will now be made to the accompanying drawings, showing by way of illustration an illustrative embodiment thereof, and in which:

FIG. 1 provides a front perspective view of a clinching tool in accordance with an illustrative embodiment of the present invention;

FIG. 2 provides a top perspective view of a clinching tool detailing the punch and die mechanisms in accordance with an illustrative embodiment of the present invention;

FIG. 3A provides a front perspective view of a punch in accordance with an illustrative embodiment of the present invention;

FIG. 3B provides a front perspective view of a punch in accordance with an alternative illustrative embodiment of the present invention;

FIG. 4 provides a front perspective view of a die in accordance with an illustrative embodiment of the present invention;

FIG. 5A provides a sectional view of a punch and die in accordance with an illustrative embodiment of the present invention;

FIG. 5B provides a detailed sectional view of a die cavity in accordance with an illustrative embodiment of the present invention;

FIG. 6A provides a sectional view of a punch and die with a pair of sheets placed there between in accordance with an illustrative embodiment of the present invention;

FIG. 6B provides a sectional view of a punch and die with a pair of sheets drawn into the die cavity in accordance with an illustrative embodiment of the present invention; and

FIG. 7 provides a detailed front perspective sectional view of a clinch in accordance with an illustrative embodiment of the present invention.

### DESCRIPTION OF THE ILLUSTRATED EMBODIMENTS

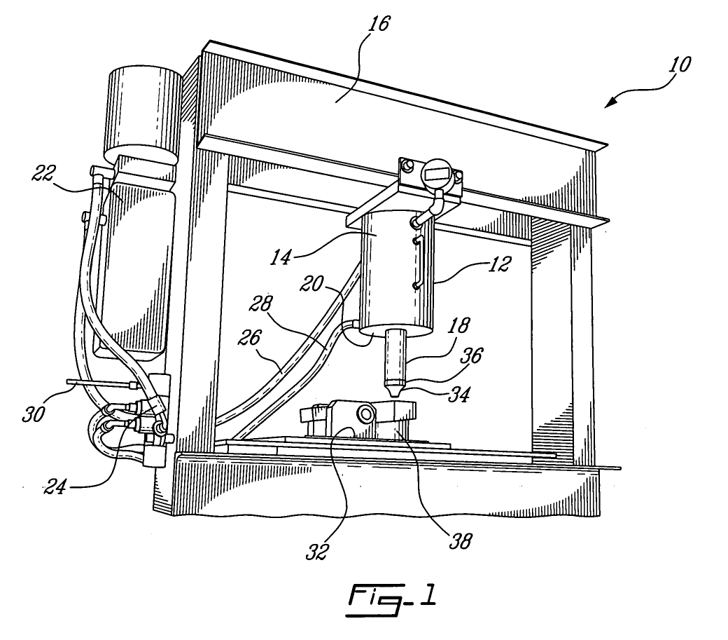

Referring now to FIG. 1, a clinching tool, generally referred to using the reference numeral 10, and in accordance with an illustrative embodiment of the present invention will now be described. The clinching tool 10 comprises a vertically mounted hydraulic cylinder 12 supported at an upper end 14 to a framework 16 manufactured from heavy structural steel or the like. A ram 18 exits a lower end 20 of the hydraulic cylinder 12 and is adapted for vertical movement relative to same. A controllable source of hydraulic fluid and pressure 22 is interconnected with the cylinder 12 via a control valve mechanism 24 and a pair of hoses 26, 28. As known in the art, the ram 18 reciprocates relative to the lower end 20 of the cylinder 14 by controlling the direction of flow of pressurised hydraulic fluid using a control valve 24. In this regard, the control valve 24 is equipped with a control lever 30 for manually controlling the direction of flow of hydraulic fluid.

Note that although the clinching tool 10 has been described using a hydraulically actuated cylinder 12 and ram 18, other types of reciprocating presses, for example pneumatic or mechanical presses, could also be used.

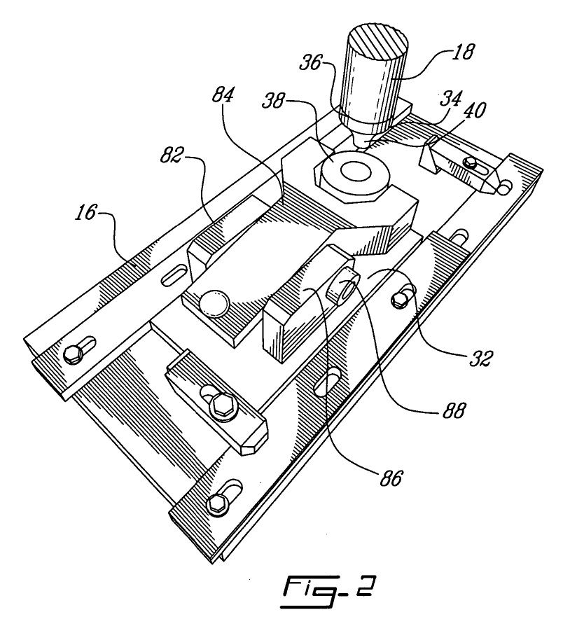

Still referring to FIG. 1, a die anvil (or bed) 32 is secured to the framework 16 below the hydraulic cylinder 12 and ram 18 assembly. Referring now to FIG. 2 in addition to FIG. 1, a punch 34 is removeably secured to an end 36 of the ram 18 and moves with the ram 18 relative to a die 38. The die 38 is held securely yet removeably in the die anvil 32 illustratively using a collet type mount.

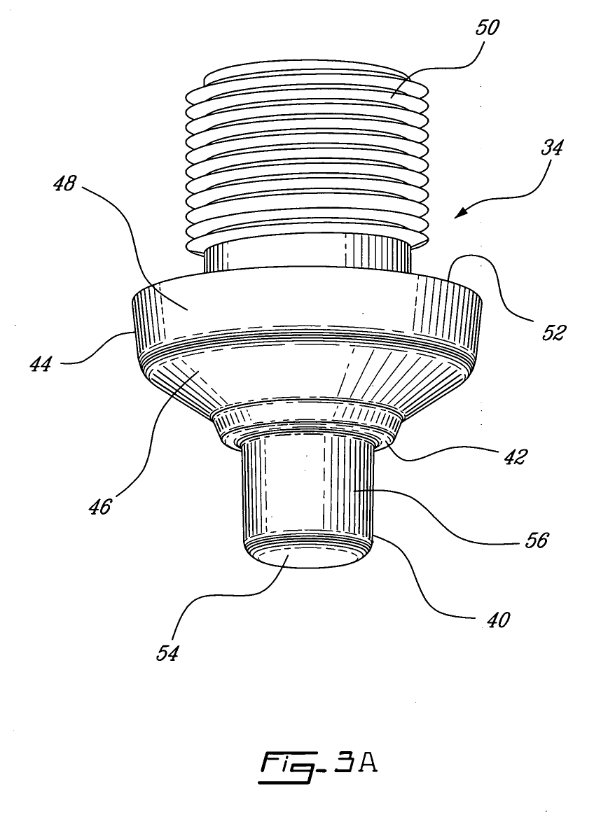

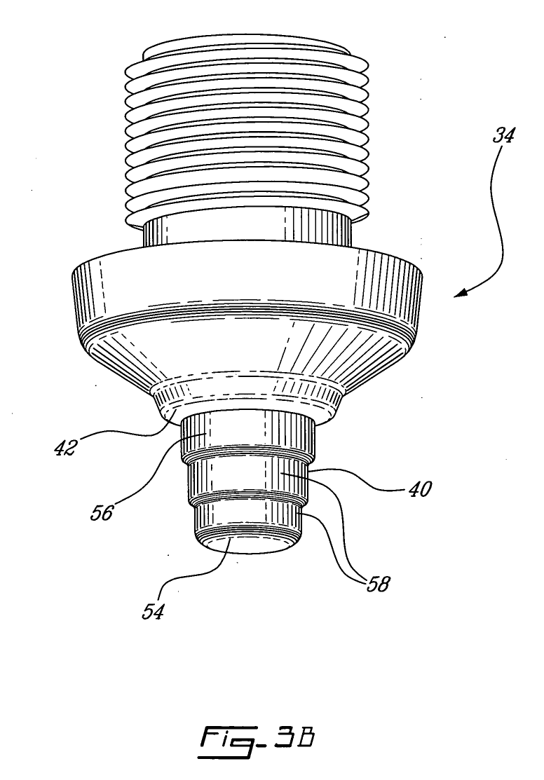

Referring now to FIG. 3A, the punch 34, which may be constructed for example of heat treated D2 tool steel, powdered metallurgical tool steel (PM tool steel, such as Vanadis 6®), or other materials of the like, is presented in this illustrative embodiment as having a circular cross section. It should be understood that, although the present illustrative embodiment discloses a punch having generally circular cross sections, other cross sections, for example square, rectangular or oblong, would also provide suitable punch shapes.

Still referring to FIG. 3A, punch 34 comprises an elongated punch tip 40 of circular cross section extending downwardly from a flat annular punch shoulder 42. A punch base 44, comprising an inverted frustum portion 46 and a cylindrical portion 48 extends upwardly and outwardly therefrom. A threaded punch fastening post 50 which is smaller than the cylindrical section 48 of the punch base 44 is integrally attached thereto thus defining an annular shelf 52 at their juncture. Referring back to FIG. 2, as will now be apparent to one of ordinary skill in the art, the punch 34 is secured to the ram 18 simply by inserting the threaded punch fastening post 50 into a threaded opening (not shown) machined into the end 36 of the ram 18 and tightening the punch 34 until the annular shelf 52 is resting tightly against the end 36 of the ram 18. While securely fastened to the ram 18, the punch 34 remains easily accessible and quickly interchangeable.

Referring back to FIG. 3A, the punch tip 40 comprises a convex or rounded tip end surface 54, which facilitates penetration of the punch tip 40 into the stacked sheets to be clinched (not shown), thus relieving excess tooling material stresses and reducing the likelihood of premature tooling failure. The addition of the rounded tip end surface 54 improves the drawing of material into the die by reducing the shearing action of the punch tip 40. This attribute is particularly advantageous when clinching thick materials, namely in the range of about 0.25 to about 1.00 inch (about 6.3 mm to about 25.4 mm) thick sheet stacks, but can also be useful for clinching thinner materials as reduced clinching pressures are inherently required to complete the same task. In the present illustrative embodiment the punch tip 40 at the rounded tip end surface 54 has a diameter of about 0.716 inches (about 18.2 mm) at the rounded tip end surface 54 of the punch tip 40 is illustratively machined with a convex profile having a radius of about 3 inches (about 76.2 mm).

Still referring to FIG. 3A, the punch tip 40 is illustratively frustum shaped, whereby the outer peripheral wall 56 of the punch tip 40 is tapered towards the rounded tip end surface 54. Illustratively, the diameter of the punch tip 40 decreases linearly as one moves away from the punch shoulder 42 towards the tip end surface 54, which facilitates the removal of the punch tip 40 from clinched sheets once a clinch has been formed. In an illustrative embodiment of the present invention, the outer peripheral wall 56 forms an angle of about 0° to about 6° with the longitudinal axis of the punch 34. In an alternative illustrative embodiment of the present invention, the outer peripheral wall 56 forms an angle of about 2° to about 4° with the longitudinal axis of the punch 34. In still a further alternative illustrative embodiment of the present invention, the outer peripheral wall 56 forms an angle of about 3° with the longitudinal axis of the punch 34.

Referring now to FIG. 3B, in an alternative illustrative embodiment of the present invention the punch 34 is comprised of a punch tip 40 machined such that the outer peripheral wall 56 has a ridged (or stepped) profile comprised of two or more concentric disk portions as in 58. The concentric disk portions as in 58 are of decreasing diameter as one moves away from the punch shoulder 42 towards the tip end surface 54.

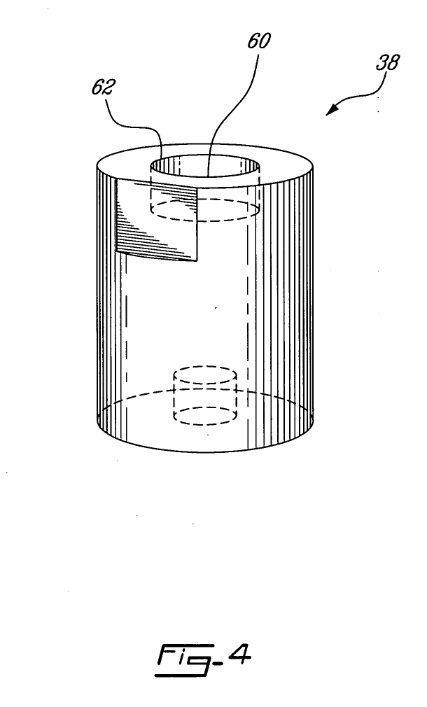

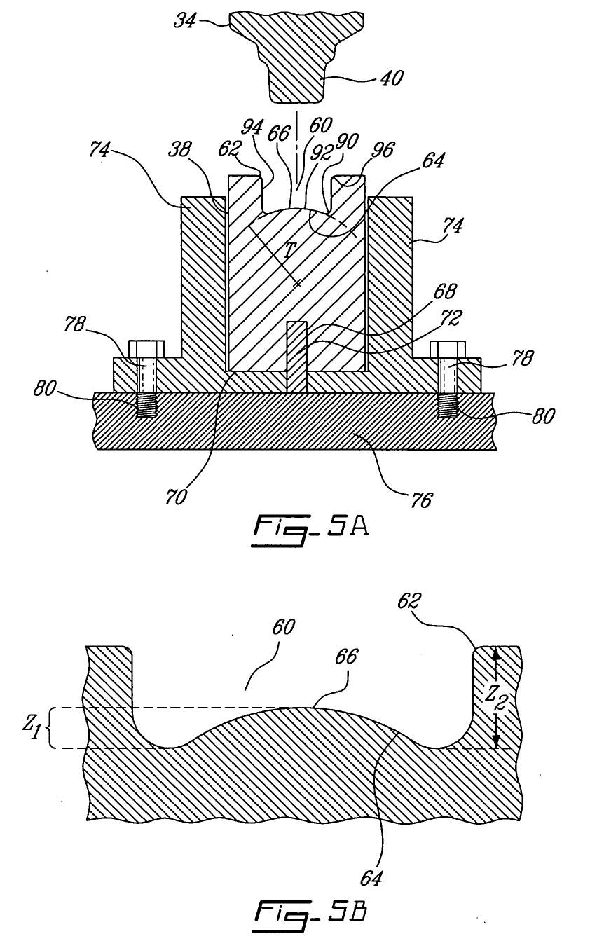

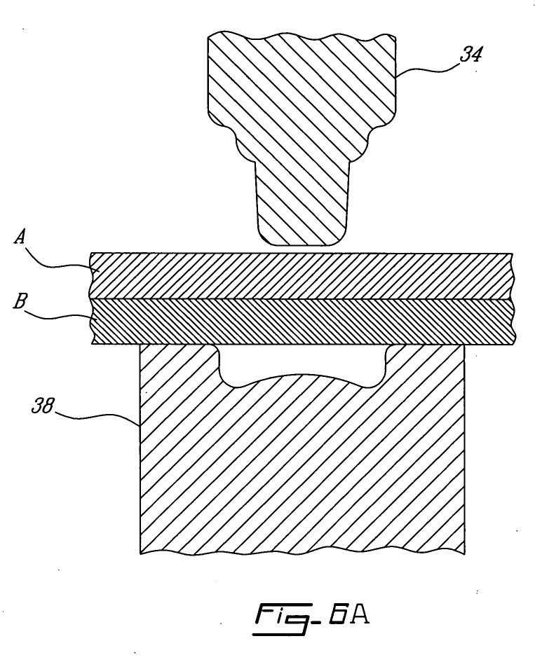

Referring now to FIG. 4 and FIG. 5A, the die 38 is also presented in this illustrative embodiment as having a cylindrical symmetry. The die is manufactured, for example, from heat treated D2 tool steel, powdered metallurgical tool steel (PM tool steel, such as Vanadis 4®) or the like. The die 38 comprises a die cavity 60 comprising an open end 62 and a closed end 64. An inner surface 66 of the closed end 64 has a raised surface profile, illustratively curved and convex, and having a radius R of about 1.35 inches (about 35 mm). Illustratively, the die 38 further comprises a dowel hole 68 in a base end 70 thereof. A dowel 72, which forms part of the die anvil 32, is centred and aligned with the punch tip 40, and serves to guide and align the die 38. A set of die anvil walls 74, as discussed above in this illustrative embodiment comprising a collet style mounting, tightly accepts the die 38; thereby securing the die 38 in place while allowing the die 38 to be easily interchanged. The die anvil 32 is in turn secured to a clinching base 76, or table, by a suitable fastening means, illustratively a set of bolts 78 which are inserted and tightened into threaded openings 80 in the base 76.

Referring back to FIG. 2, in an alternative illustrative embodiment of the present invention, the die anvil 32 further comprises a stripping mechanism 82 comprised of a stripper 84 mounted to a base 86 using a hinge mechanism 88 around which the stripper 84 can pivot. The stripping mechanism 82 facilitates removal of clinched sheets from the clinching tool 10.

Referring now to FIG. 5A, the raised surface profile of the inner surface 66 of the closed end 64 comprises a rounded annular depression 90 at its periphery and a convex or domed protrusion 92 towards the centre of the surface 66. The raised surface profile of the surface 66 facilitates movement of the ductile metal sheets within the die cavity 60 during clinching (as discussed hereinbelow), relieving excess tooling material stresses and thereby reducing the likelihood of premature tooling failure. This attribute is useful when clinching thick materials, namely in the range of about 0.25 inch to about 1.00 inch (about 6.3 mm to about 25.4 mm) thick sheet stacks, but can also be useful for clinching thinner materials.

Still further in accordance with an illustrative embodiment of the present invention, the die cavity 60 is of a slight frustum shape where a cavity peripheral wall 94 tapering inwards from the open end 62 to the closed end 64. Illustratively, a circular cross section of the die cavity 60 decreases linearly from the open end 62 to the closed end 64. The frustum shape of the die cavity 60 facilitates the removal of the clinched sheets from the die cavity 60 once the clinch is formed. In an illustrative embodiment of the present invention, the cavity peripheral wall 94 forms an angle of about 0° to about 6° with the longitudinal axis of the die 38. In an alternative illustrative embodiment of the present invention, the die peripheral wall 94 forms an angle of about 2° to about 4° with the longitudinal axis of the die 38. In still a further alternative illustrative embodiment of the present invention, the cavity peripheral wall 94 forms an angle of about 3° with the longitudinal axis of the die 38.

Still referring to FIG. 5A, the open end 62 of the die cavity 60 comprises a rounded shoulder 96. The rounded shoulder 96 provides for smoother penetration of the ductile metal sheets into the die cavity 60 during a clinching action.

Referring now to FIG. 5B, the height Z₁ of the raised surface profile of the surface 66 of the closed end 64 is illustratively between 25% and 35% of the maximum depth Z₂ of the die cavity 60.

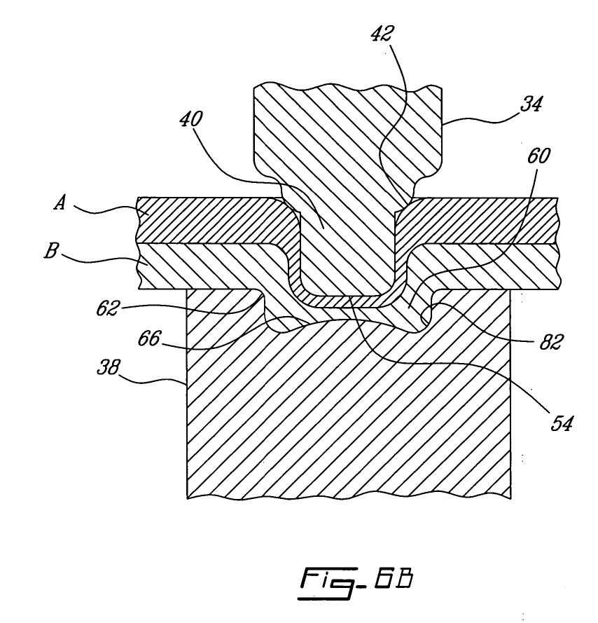

Referring to FIG. 6A, in order to clinch sheets of ductile material, the sheets (A & B) are positioned side by side and placed between the punch 34 and die 38. Referring now to FIG. 6B, as the punch 34 is lowered by the ram 18, the punch tip 40 makes contact with a first sheet A. Continued downward motion of the punch 34 forces the punch tip 40 into the first ductile sheet A and a second ductile sheet B causing material from the ductile sheets A and B to move into the die cavity 60. As the rounded tip end surface 54 reaches the level of the open end 62 of the die 38 a clinching action takes place, wherein a clinch volume of the material of the ductile sheets A and B is drawn into the die cavity 60 through the die opening 32. As the rounded tip end surface 54 enters the die cavity 60, the ductile sheets A and B are compressed between the rounded tip end surface 54 and the raised surface profile 66, thereby causing the material of the ductile sheets A and B to be deformed, this creating a mechanical interlock between the ductile sheets A and B in the region of the clinch.

Still referring to FIG. 6, the punch shoulder 42 serves to prevent necking (over drawing of the ductile sheets A and B) due to over travel of the punch 34 and to limit the penetration of the punch tip 40 into the material of the sheets A and B. The punch shoulder 42 also helps to some degree to force the material of the sheets A and B into the die cavity 60, thereby improving the quality of the clinch. Once the clinch is formed, the clinching action is reversed, and the punch tip 40 extracted from the clinch form in the sheets A and B. The clinch fastened sheets A and B are then removed from the clinching tool 10.

Note that although the above illustrative embodiment has been illustrated using a pair of sheets A and B, the present invention could also be used for clinch fastening more than two (2) sheets.

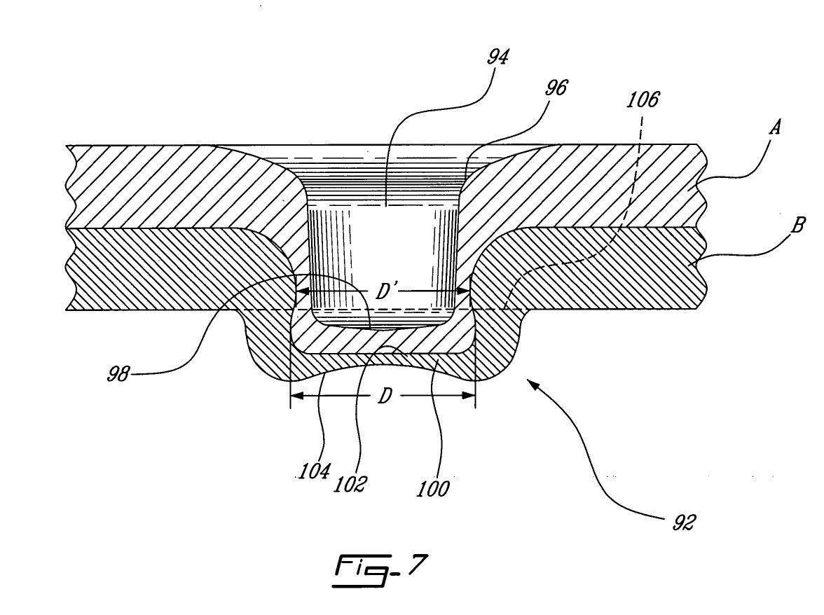

Referring now to FIG. 7, a typical cross section of a sample clinch 92 reveals, in an illustrative embodiment of the present invention, a punch cavity 94 on a first side of the sheets defined by an inverted thimble like volume with a circular opening 96 and a rounded closed face 98. A lower face 100 of the sheet A and an upper face 102 of the sheet B are generally smooth and in contact, and follow the profile of the punch tip (40 in FIG. 3A) in the region of the clinch 92. This maintains a substantially constant thickness of the sheet A along the rounded closed face 98. A bottom surface 104 of the sheet B has substantially the same shape as the profile of the die cavity (60 in FIG. 6). Superior clinches are those where the ductile of material of sheets A and B are deformed in a manner that a mechanical interlock is formed between the sheets below a lower surface 106 of the sheet in closest proximity to the die (in the case at hand, sheet B). In this regard, those clinches where a diameter D of the lower face 100 of the first sheet A is greater than the diameter D′ of the clinch in the second sheet B provide such a mechanical interlock (i.e. a bulge formed in the ductile material of the first sheet A in the region of the clinch interlocks with a corresponding bulge formed in the ductile material of the second sheet B).

In order to examine the suitably of punch/die combinations, punches and dies having different diameters and depths were tested using samples of copper sheets, each of the sheets having a thickness of about 0.380 inches (about 9.7 mm) for a total composite thickness of about 0.760 inches (about 19.3 mm). TABLE 1 provides an overview of the test results.

TABLE 1

| PUNCH | DIE | RATING |
|---|---|---|
| 0.794″ (20.2 mm) diameter | 1.24″ (31.5 mm) diameter | Passable* |
| Flat nose | 0.33″ (8.4 mm) depth | |
| 0.794″ (20.2 mm) diameter | 1.300″ (33 mm) diameter | Very Good |
| Flat nose | 0.375 (9.5 mm) depth | |
| 0.748″ (19 mm) diameter | 1.24″ (31.5 mm) diameter | Passable* |
| 1″ (25.4 mm) radius on nose | 0.295″ (7.5 mm) depth | |
| 0.748″ (19 mm) diameter | 1.24″ (31.5 mm) diameter | Failed** |
| 1″ (25.4 mm) radius on nose | 0.33″ (8.4 mm) depth | |
| 0.748″ (19 mm) diameter | 1.300″ (33 mm) diameter | Passable* |
| 1″ (25.4 mm) radius on nose | 0.375 (9.5 mm) depth | |
| 0.704″ (17.9 mm) diameter | 1.24″ (31.5 mm) diameter | Very Good |
| Flat nose | 0.295″ (7.5 mm) depth | |
| 0.704″ (17.9 mm) diameter | 1.24″ (31.5 mm) diameter | Very Good |
| Flat nose | 0.33″ (8.4 mm) depth | |
| 0.704″ (17.9 mm) diameter | 1.24″ (31.5 mm) diameter | Excellent |
| Flat nose | 0.33″ (8.4 mm) depth | |
| 0.724″ (18.4 mm) diameter | 1.24″ (31.5 mm) diameter | Good |
| 3″ (76.2 mm) radius on nose | 0.33″ (8.4 mm) depth | |
| 0.724″ (18.4 mm) diameter | 1.24″ (31.5 mm) diameter | Good |
| 3″ (76.2 mm) radius on nose | 0.33″ (8.4 mm) depth | |
| 3 Step | 1.24″ (31.5 mm) diameter | Passable*** |
| 3″ (76.2 mm) radius on nose | 0.295″ (7.5 mm) depth | |
| 3 Step | 1.24″ (31.5 mm) diameter | Passable*** |
| 3″ (76.2 mm) radius on nose | 0.33″ (8.4 mm) depth | |

*clinch outside of die
**not enough clinch
***die not completely filled

Note that in the above table, depth refers to the deepest (or lowest) point in the die.

While this invention has been described with reference to the illustrative embodiments, this description is not intended to be construed to a limiting sense. Various modifications or combinations of the illustrative embodiments, as well as other embodiments of the invention, will be apparent to persons skilled in the art upon reference to the description. It is therefore intended that the described invention encompass any such modifications or embodiments.

What is claimed is:

1. A die for use with a punch for mechanically interconnecting a plurality of sheets of a ductile material, the die comprising:
a die cavity comprising a closed end, wherein an inner surface of said closed end has a raised surface profile.

2. The die as in claim 1, wherein said raised profile is curved.

3. The die as in claim 2, wherein said curved profile has a radius of curvature.

4. The die as in claim 2, wherein said curved profile is convex.

5. The die as in claim 3, wherein said curved profile has a radius which is greater than one half a width of said die cavity.

6. The die as in claim 5, wherein said curved profile radius is greater than said die cavity width.

7. The die as in claim 4, wherein said die cavity is substantially cylindrical and said convex profile has a radius which is greater than a radius of said die cavity.

8. The die as in claim 7, wherein said convex radius is greater than said die cavity radius.

9. The die as in claim 1, wherein said raised surface profile comprises an annular depression at a periphery of said closed end and a protrusion in a central region of same.

10. The die as in claim 1, wherein a height of said raised surface is between about 25% and 35% of a maximum depth of said die cavity.

11. The die as in claim 1, wherein said die is a one-piece die.

12. The die as in claim 1, wherein said die cavity is frustum shaped and comprises an outwardly tapered wall extending from said closed end.

13. The die as in claim 12, wherein said tapered wall forms an angle of between about 0° to about 6° with a longitudinal axis of said die.

14. The die as in claim 13, wherein said angle is between about 2° and about 4°.

15. The die as in claim 14, wherein said angle is about 3°.

16. A clinching tool for clinch fastening at least two stacked sheets of a ductile material, the clinching tool comprising:
a punch;
a die comprising a die cavity, a closed end of said cavity having a raised surface profile; and
a controllable source of pressure between said punch and said die;
wherein when said source of pressure is applied between said punch and die, said punch draws a clinch volume of the sheets substantially completely into said die cavity.

17. The clinching tool of claim 16, wherein said die is a one-piece die.

18. The clinching tool of claim 16, wherein said raised surface is curved.

19. The clinching tool of claim 18, wherein said raised curved surface is convex.

20. The clinching tool of claim 16, wherein a height of said raised surface is between about 25% and about 35% of a maximum depth said die cavity.

21. The clinching tool of claim 16, wherein said die cavity further comprises walls extending inwardly from said closed end to an open end thereof, said walls defining a variable cavity cross section.

22. The clinching tool of claim 21, wherein said walls are angled inwardly from said open end to said closed end.

23. The clinching tool of claim 22, wherein said walls are at an angle of between about 0° to about 6° to a longitudinal axis of said die cavity.

24. The clinching tool of claim 22, wherein said angle is between about 2° to about 4°.

25. The clinching tool of claim 22, wherein said angle is about 3°.

26. The clinching tool of claim 16, wherein said punch comprises a punch tip comprising a tip end surface and wherein said punch tip is tapered towards said tip end surface.

27. The clinching tool of claim 26, wherein said punch tip has a taper angle of between about 0° to about 6° to a longitudinal axis of said punch.

28. The clinching tool of claim 27, wherein said taper angle is between about 2° to about 4°.

29. The clinching tool of claim 28, wherein said taper angle is about 3°.

30. The clinching tool of claim 26, wherein said tip end surface is rounded.

31. The clinching tool of claim 26, wherein said punch further comprises a punch shoulder.

32. The clinching tool as claimed in 16, wherein said ductile material is a metal.

33. The clinching tool as claimed in 16, wherein said ductile material is an alloy.

34. The clinching tool as claimed in 16, wherein said ductile material is selected from the group consisting of copper, aluminium, steel and iron.

35. The clinching tool as claimed in 16, wherein said stacked sheets have a combined thickness between ¼ and 1 inch.

36. The clinching tool as claimed in 16, wherein said stacked sheets are copper cathodes.

37. The clinching tool as claimed in 16, wherein there are two stacked sheets.

38. The clinching tool of claim 16, wherein said a controllable source of pressure is at least 50 thousand tons.

39. The clinching tool of claim 38, wherein said a controllable source of pressure is about 65 thousand tons.

40. A method for mechanically interconnecting a stack of at least two sheets of a ductile material, the method comprising the steps of:
providing a die comprising a die cavity, a closed end of said cavity having a raised surface profile;
drawing a clinch volume of the at least two sheets into said die cavity, said clinch volume being deformed by said die such that adjacent sheets are joined by a mechanical interconnection; and
stripping said sheets from said die.

41. The method of claim 40, wherein said die is a one-piece die.

42. The method of claim 40, further comprising a punch comprising a punch tip, and wherein said drawing step comprises moving said punch relative to said die until said punch tip is inside said die cavity.

43. The method of claim 42, wherein said punch further comprises a punch shoulder and said drawing step comprises pressing said punch tip into said die cavity until said shoulder contacts the sheets.

44. The method of claim 42, wherein said punch tip comprises a tip end surface and punch tip side walls, said side walls being tapered towards said tip end surface.

45. The method of claim 44, wherein said tip end surface is rounded.

46. The method of claim 40, wherein said raised surface profile is curved.

47. The method of claim 46, wherein said curved profile is convex.

48. The method of claim 40, wherein said raised surface profile comprises an annular depression at a periphery of said closed end and a protrusion towards a central region thereof.

49. The method of claim 48, wherein a height of said raised surface is between about 25% and 35% of a maximum depth of said die cavity.

50. The method of claim 40, wherein said die cavity is frustum shaped and comprises an outwardly tapered wall extending from said closed end.

51. The method of claim 42, wherein said stripping step comprises the steps of:
retracting said punch tip from said die cavity; and
removing the interconnected sheets from said die using a stripping mechanism.

52. The method of claim 40, wherein said mechanical interconnection is formed below an outer surface of the sheet in closest proximity to said die.

53. A mechanically interconnected stack of at least two ductile sheets, the stack comprising:
at least one region of deformation, wherein each of the sheets is deformed in said region of deformation, each of said deformations interacting together to form a mechanical bond; and
a protrusion on a first surface of the stack in said region of deformation, said protrusion comprising a curved depression towards a centre thereof.

54. The stack of claim 53, wherein said curved depression is concave.

55. The stack of claim 53, further comprising an indentation on an opposite surface of said stack from said first surface in said region of deformation.

56. The stack of claim 55, wherein said indentation and said protrusion are substantially circular.

57. The stack of claim 56, said indentation further comprising a tapered side wall towards a closed end thereof.

58. The stack of claim 55, said indentation further comprising a curved closed end.

59. The stack of claim 58, wherein said curved closed end is convex.

60. The stack of claim 57, wherein said wall is at an angle of between about 0° to about 6° to a longitudinal axis of said indentation.

61. The stack of claim 57, wherein said wall is at an angle of between about 2° to about 4° to a longitudinal axis of said indentation.

62. The stack of claim 57, wherein said wall is at an angle of about 3° to a longitudinal axis of said indentation.

63. A one piece die for use with a punch for mechanically interconnecting at least two sheets of a ductile material, the die comprising:
a die cavity comprising a sidewall and a bottom wall, said bottom wall defining a raised surface within said cavity.

64. The die as in claim 63, wherein said raised surface is curved.

65. The die as in claim 64, wherein said curved raised surface has a radius of curvature.

66. The die as in claim 65, wherein said curved raised surface is convex.

67. The die as in claim 66, wherein said die cavity is substantially cylindrical and said convex surface has a radius which is greater than a radius of said die cavity.

68. The die as in claim 67, wherein said convex surface is greater than said die cavity radius.

69. The die as in claim 63, wherein said raised surface comprises an annular depression at a periphery of said bottom wall and a protrusion in a central region of same.

70. A die for use with a punch for mechanically interconnecting at least two sheets of a ductile material, the die comprising:
a die cavity comprising a sidewall and a bottom wall, said bottom wall defining a curved surface within said cavity.

71. The die as in claim 70, wherein said curved raised surface has a radius of curvature.

72. The die as in claim 71, wherein said curved raised surface is convex.
